(19) United States
(12) Patent Application Publication
(10) Pub. No.: US 2024/0378198 A1
(43) Pub. Date: Nov. 14, 2024

(54) GENERATING TRAINING EXAMPLES FOR TRANSLATION OF NATURAL LANGUAGE QUERIES TO EXECUTABLE DATABASE QUERIES

(71) Applicant: SRI International, Menlo Park, CA (US)

(72) Inventors: Mario Latendresse, Menlo Park, CA (US); John Cadigan, San Diego, CA (US)

(21) Appl. No.: 18/391,339

(22) Filed: Dec. 20, 2023

Related U.S. Application Data
(60) Provisional application No. 63/465,727, filed on May 11, 2023.

(51) Int. Cl. G06F 16/2452; G06F 16/242; G06F 40/253

(52) U.S. Cl. CPC G06F 16/24522; G06F 16/2425; G06F 40/253

(57) ABSTRACT

In an example, a method includes, generating, by a machine learning system, one or more formal queries based on data contained in a database repository; generating, by the machine learning system, a natural language query for each formal query of the one or more formal queries to generate pairs of formal queries and corresponding natural language queries by applying a general grammar for a language of each formal query; and training, by the machine learning system, a neural network configured to translate natural language queries into formal queries using the pairs of the formal queries and corresponding natural language queries generated by the machine learning system.

This application claims the benefit of U.S. Patent Application No. 63/465,727, filed May 11, 2023, which is incorporated by reference herein in its entirety.

### TECHNICAL FIELD

This disclosure is related to natural language processing, and more specifically to generation of relevant training examples to translate natural language queries to executable database queries for machine learning.

### BACKGROUND

Currently, to query complex databases, in particular scientific databases (e.g., biology and chemistry databases), users typically use one of the following two methods: (1) filling out forms with specific details of a query, or (2) using formal query languages such as Structured Query Language (SQL). Filling out forms is a common approach for querying databases that is somewhat user-friendly. Users are presented with a form that contains fields for the different criteria that they want to use to filter the data. For example, a user might query a biology database for all genes that are expressed in the liver and that are involved in cell signaling. SQL is a powerful query language that allows users to interact with relational databases. SQL queries are typically written in text format and can be quite complex. For example, a user might write a SQL query to retrieve all genes from a biology database that are expressed in the liver and that have a sequence similarity of at least 80% to a particular gene.

Both of the aforementioned methods have their own advantages and disadvantages. Filling out forms is a relatively easy way to query a database, but it can be limiting if users need to create a complex query. SQL is a powerful query language, for instance, but it can be difficult to learn and use.

### SUMMARY

The disclosure describes techniques that involve generation of training examples that are relevant to the translation of natural language queries to executable database queries.

As described in herein, a computing system generates relevant training examples that translate natural language queries to executable database queries. These training examples can then be used to train a machine learning system. To generate the relevant training examples, the system uses data from the database to be queried to generate relevant questions for the user in a natural language. This approach is combined with the appropriate vocabulary to use and its meaning in terms of processing the data, as provided by a domain expert, when querying the database. Consequently, the generation of formal queries, understandable by the database engine, may first be implemented based on the data in the database. Then, natural language queries can be generated, based on a general grammar, that understand the formal queries to the database. This general grammar may be created once for each possible formal grammar.

In an aspect, natural language questions may be automatically generated based on a general grammar that understands the formal queries. This general grammar may be created once for each formal grammar of interest, such as for SQL or Simple Protocol and Resource Development Framework (RDF) Query Language (SPARQL). The system generates a list of relevant formal queries based on the data in the database, and then generates relevant natural language questions for the formal queries using the general grammar for the database. These pairs of formal queries and natural language questions constitute the training pairs for the machine learning model that translates natural language questions to formal queries for the database. Generation of relevant questions may be implemented using a variety of techniques, such as, but not limited to, NLP and machine learning. For example, the disclosed system may identify the most important entities and relationships in the database and then may generate questions that are likely to be of interest to users, using values from the database.

The techniques may provide one or more technical advantages that realize at least one practical application. For example, the techniques may improve the technical field of databases and database interfacing by providing easier and more natural access when querying complex databases, in particular when querying scientific databases. More specifically, the described techniques may improve the ability of database users to use natural language query processing (NLP) that allows the users to query databases using their natural language. NLP in this way make it easier for users to create complex queries without having to learn a query language. For example, the disclosed techniques may provide a natural language query interface that implements a machine learning model trained using the training examples generated according to the described techniques. The natural language query interface may allow users to type or speak questions in their natural language. The interface may then apply the trained machine learning model to translate a natural language question (or “natural language query”) into a formal query that the database engine can understand. Advantageously, the disclosed techniques may make it easier for users to access and analyze scientific data. The training data of relevant training pairs improve on manual generation of such pairs, in that the relevant training pairs are generated more quickly, are less error prone, are sufficient for training a machine learning model, have increased diversity, and—because they are generated based in part on actual values of the database to be queried—will tend to be more realistic.

In an example, a method includes, generating, by a machine learning system, one or more formal queries based on data contained in a database repository; generating, by the machine learning system, a natural language query for each formal query of the one or more formal queries to generate pairs of formal queries and corresponding natural language queries by applying a general grammar for a language of each formal query; and training, by the machine learning system, a neural network configured to translate natural language queries into formal queries using the pairs of the formal queries and corresponding natural language queries generated by the machine learning system.

In an example, a system includes processing circuitry in communication with storage media, the processing circuitry configured to execute a machine learning system configured to: generate one or more formal queries based on data contained in a database repository; generate a natural language query for each formal query of the one or more formal queries to generate pairs of formal queries and corresponding natural language queries by applying a general grammar for a language of each formal query; and train a neural network configured to translate natural language queries into formal queries using the pairs of the formal queries and corresponding natural language queries.

In an example, non-transitory computer-readable storage media having instructions encoded thereon, the instructions configured to cause processing circuitry to: generate one or more formal queries based on data contained in a database repository; generate a natural language query for each formal query of the one or more formal queries to generate pairs of formal queries and corresponding natural language queries by applying a general grammar for a language of each formal query; and train a neural network configured to translate natural language queries into formal queries using the pairs of the formal queries and corresponding natural language queries.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a high-level block diagram illustrating an example computer-based system for generation of relevant training examples in accordance with the techniques of the disclosure.

FIG. 2 is a detailed block diagram illustrating an example system in accordance with the techniques of the disclosure.

FIG. 3 is a conceptual diagram illustrating an example of a data augmentation framework according to techniques of this disclosure.

FIG. 4 is a conceptual diagram illustrating an example scientific database according to techniques of this disclosure.

FIG. 5 is a conceptual diagram illustrating an example query generation method according to techniques of this disclosure.

FIG. 6 is a flowchart illustrating an example mode of operation for a machine learning system, according to techniques described in this disclosure.

Like reference characters refer to like elements throughout the figures and description.

### DETAILED DESCRIPTION

The disclosure describes techniques for generation of relevant training examples for training a machine learning system to translate natural language queries to executable database queries.

In recent years, there has been a growing interest in developing new ways to query complex databases. One technique that has gained popularity is to use natural language query processing (NLP). NLP allows users to query databases using a natural language, such as, but not limited to, English. NLP may make it easier for users to create complex queries without having to learn a query language.

Another technique that is being explored is to use machine learning to help users query databases. Machine learning models may be trained to understand the relationships between the different entities in a database. Machine learning models may allow users to generate relevant queries from natural language questions or to help users refine their queries. However, there are some challenges of querying complex databases. Scientific databases often contain large amounts of data that are structured in a complex way. Such a complex structure may make it difficult for users to write effective queries that retrieve the data that they need. Scientific databases may contain billions or even trillions of records. Accordingly, the size of a scientific database may make it difficult to query such database efficiently. Furthermore, many users of scientific databases do not have expertise in query languages such as SQL. Lack of expertise may make it difficult for users to create complex queries.

Generation of natural language queries for each formal query may be implemented using a general grammar that understands the formal queries. A machine learning model of a machine learning system may be trained on the generated pairs of natural language queries and formal queries. This training may train the machine learning model to learn the relationship between natural language queries and formal queries. The trained machine learning model may be used to translate new natural language queries to executable database queries. The disclosed system has a number of advantages. For example, the disclosed system is able to generate complex queries without the need for users to learn a query language.

In addition, the disclosed system is able to generate accurate and relevant queries even if the user does not use the exact vocabulary of the database.

One of the key challenges of training machine learning systems is generation of relevant training examples. Such generation may be difficult or even impossible to do manually, especially for complex databases. However, the disclosed techniques may be used to generate synthetic training examples.

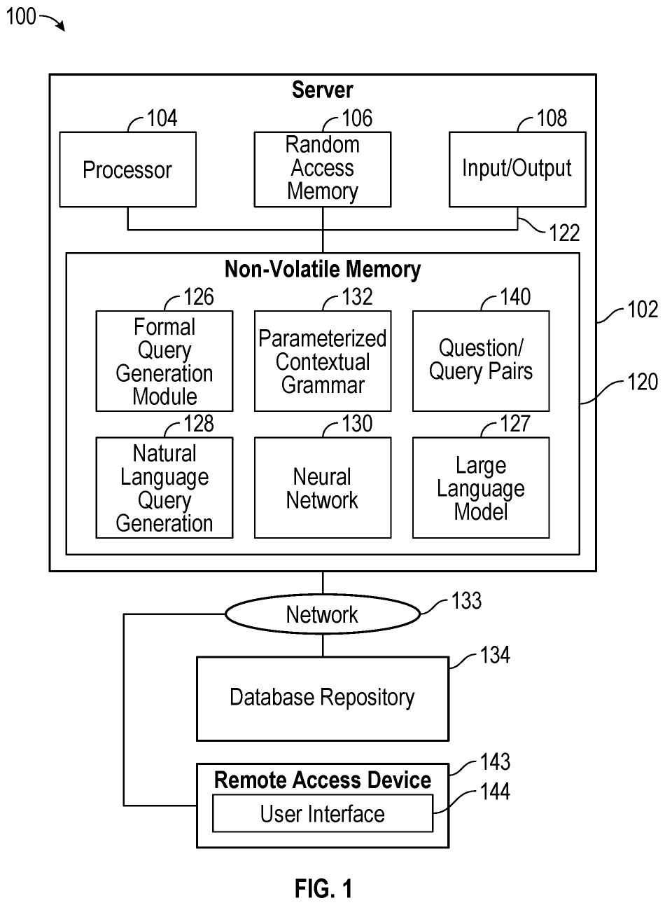

FIG. 1 is a block diagram of an example computing system 100, in accordance with one or more techniques of this disclosure. Computing system 100 is only one example and is not intended to suggest any limitation as to the scope of use or functionality of the disclosure. Neither should the computing system 100 be interpreted as having any dependency or requirement relating to any one or combination of illustrated components. For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules may include routines, programs, objects, components, data structures, loop code segments and constructs, etc. that may perform particular tasks or implement particular abstract data types. The disclosure may be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art may implement the description and figures as processor executable instructions, which may be written on any form of a computer readable media. In one implementation, with reference to FIG. 1, the system 100 may include one or more server device(s) 102 each configured to include a processor 104, such as a central processing unit (CPU), random access memory (RAM) 106, one or more input-output devices 108, such as a display device (not shown) and keyboard (not shown), and non-volatile memory 120, all of which are interconnected via a common bus 122 and controlled by the processor 104. Where there are multiple servers 102, the servers 102 are interconnected by network 133.

As shown in the FIG. 1 example, in one implementation, the non-volatile memory 120 may be configured to include a formal query generation module 126 for generating one or more formal queries based on the values in the database repository 134.

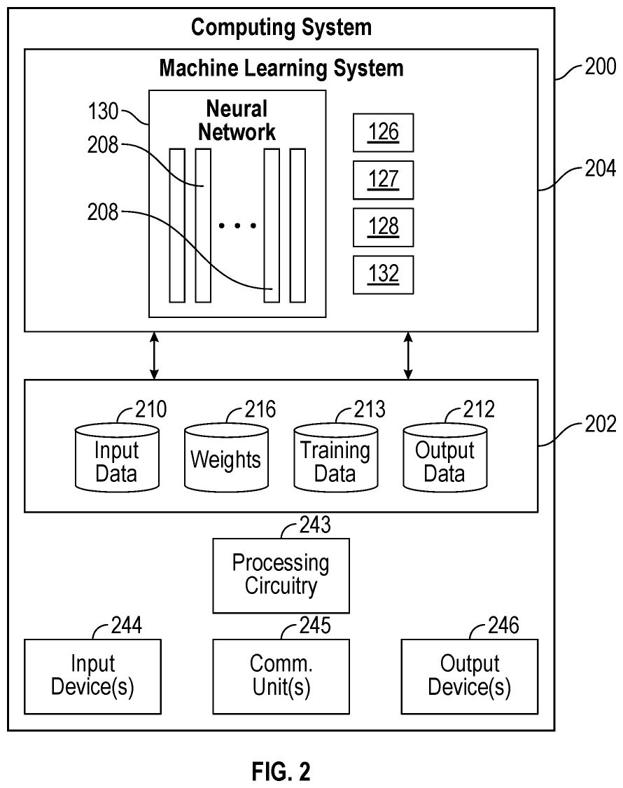

In an aspect, a natural language query generation module 128 may also be provided converting each of the one or more formal queries into a natural language query. In addition, a parameterized contextual grammar module 132 may be provided for generating a parameterized grammar. The non-volatile memory 120 may further include a neural network 130 for translating user's natural language queries into formal queries. The neural network may be trained using a set of pairs 140 of natural language questions generated by the natural query generation module 128 and their corresponding formal queries generated by the formal query generation module 128. Each pair included in the set of pairs 140 represents a known relationship existing between natural language questions and their corresponding formal queries. Additional details of these modules 126, 128, 130 and 132 are discussed in connection with FIGS. 2, 3 and 4.

In a further aspect, server(s) 102 may include in non-volatile memory 120 a pre-trained large language model 127 for fine tuning pre-trained neural network 130. Neural network module 130 may be a machine-learning classifier configured to translate natural language queries into formal queries. A user interface 144 operated by a user at access device 143 may be used for querying or otherwise interrogating the database repository 134 (e.g., scientific database) for responsive information, e.g., use of SPARQL query techniques. Responsive data outputs may be generated at the server(s) 102 and returned to remote access device 143 and presented and displayed to the associated user.

As shown in FIG. 1, in one implementation, a network 133 may be provided that may include various devices such as routers, server, and switching elements connected in an Intranet, Extranet or Internet configuration. In one implementation, the network 133 may use wired communications to transfer information between an access device (not shown), the server device 102, and a database repository 134. In another implementation, the network 133 may employ wireless communication protocols to transfer information between the access device, the server device 102, and the database repository 134. In yet other implementations, the network 133 may employ a combination of wired and wireless technologies to transfer information between the access device, the server device 102, and the database repository 134.

The database repository 134 may be a repository that stores information utilized by the before-mentioned modules 126, 128, 130 and 132, such as, but not limited to a scientific database. In one implementation, the database repository 134 may be a relational database. In other implementations, the database repository 134 may be a hierarchical database or a graph database.

Although the database repository 134 shown in FIG. 1 is connected to the network 133, it will be appreciated by one skilled in the art that the database repository 134 and/or any of the information shown therein, may be distributed across various servers and be accessible to the server 112 over the network 133, be coupled directly to the server 112, or be configured in an area of non-volatile memory 120 of the server(s) 102.

Further, it should be noted that the system 100 shown in FIG. 1 is only one implementation of the disclosure. Other system implementations of the disclosure may include additional structures that are not shown, such as secondary storage and additional computational devices. In addition, various other implementations of the disclosure may include fewer structures than those shown in FIG. 1. For example, in one implementation, the disclosure may be implemented on a single computing device in a non-networked standalone configuration. Data input and requests may be communicated to the computing device via an input device, such as a keyboard and/or mouse. Data output of the system may be communicated from the computing device to a display device, such as a computer monitor.

It is to be further understood that, because some of the constituent system components and method steps depicted in the accompanying figures may be implemented in software, the actual connections between the systems components (or the method steps) may differ depending upon the manner in which the present disclosure is programmed. Given the teachings of the present disclosure provided herein, one of ordinary skill in the related art will be able to contemplate these and similar implementations or configurations of the present disclosure.

FIG. 2 is a block diagram illustrating an example computing system 200. In an aspect, computing system 200 may comprise an instance of the server 102 shown in FIG. 1. As shown, computing system 200 comprises processing circuitry 243 and memory 202 for executing a machine learning system 204 having a neural network 130 comprising a set of layers 208. Neural network 130 may be any of various types of neural networks, such as, but not limited to, recursive neural networks (RNNs), convolutional neural networks (CNNs) and deep neural networks (DNNs).

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system 200 may represent an instance of the server(s) 102 of FIG. 1. Memory 202 may represent an instance of the non-volatile memory 120 of FIG. 1.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., formal query generation module 126, large language model 127, natural language query generation module 128, neural network 130, and parameterized contextual grammar module 132), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 204 may receive input data from an input data set 210 and may generate output data 212. Input data 210 and output data 212 may contain various types of information. For example, input data 210 may include a plurality of sample questions generated by domain experts, one or more coverage parameters, a database schema, and the like. Output data 212 may include pairs of natural language queries and their corresponding formal queries, for example.

Each of layers 208 may include a corresponding set of artificial neurons. Layers 208 may include an input layer, a feature layer, an output layer, and one or more hidden layers, for example. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer. Various activation functions are known in the art, such as Rectified Linear Unit (ReLU), TanH, Sigmoid, and so on.

Machine learning system 204 may process training data 213 to train the neural network 130, in accordance with techniques described herein. For example, machine learning system 204 may apply an end-to-end training method that includes processing training data 213. Machine learning system 204 may process input data 210 to generate relevant training examples that may be included in the training data 213 as described below.

Formal query languages such as SQL are used to retrieve data from databases. These languages allow users to specify very specific criteria for the data they are looking for. For example, a user might use SQL to find all customers who live in a certain city and have made a purchase in the past month. Forms are generally easier for users to use, but they can be less flexible than formal query languages. Formal query languages may be more powerful, but they may also be more difficult to learn and use. In recent years, there has been a growing interest in developing new ways to query complex databases.

The current approach to querying structured databases using natural language (NLIDB) typically involves the use of a multi-turn dialogue system. In this approach, the user first issues a natural language query to the system. The system then attempts to parse the query and generate a corresponding formal query. The formal query is then executed against the database and the results are returned to the user.

In a non-limiting example, the user may first issue the query “List compounds that have a potency of at least 1000 and a weight smaller than 100 da”. The system may parse this query and may generate the formal query:
“SELECT *
FROM compounds
WHERE potency >=1000 AND weight <100”.

This formal query may then be executed against the database and the results may be returned to the user. The user may then issue a second query, “keep only the compounds with at least 5 bio-activities”. The conventional system may parse this second query and may generate the formal query:
“SELECT *
FROM compounds
WHERE bio_activities>=5”.

This formal query may then be executed against the results of the first query and the results may be returned to the user. The conventional multi-turn dialogue approach allows the users to refine their queries over multiple turns. The multi-turn dialogue approach may be helpful for complex queries that cannot be expressed in a single natural language query.

The current NLIDB approach makes it easier for users to query structured databases. However, there are a number of challenges that need to be addressed before NLIDB systems may be widely used. One challenge is that NLIDB systems may be difficult to develop because they require a deep understanding of both natural language and formal query languages. Another challenge is that NLIDB systems may be inaccurate because natural language is often ambiguous and may be interpreted in multiple ways.

Generating training data for NLIDB is a costly and time-consuming process. Typically, training data is generated by manually pairing natural language queries with their corresponding formal queries. This process may be error-prone, as it may be difficult to ensure that the natural language queries are representative of the queries that users will actually ask. Additionally, manually generated training data is often not diverse enough, as it may be difficult to anticipate all of the ways that users might express their queries.

Current approaches to training neural networks for NLIDB do not typically use the content of the database to generate training data. In other words, the neural network may not be able to learn the relationships between the different entities in the database. As a result, the neural network may not be able to generate accurate formal queries for queries that involve multiple entities. Current approaches to training neural networks for NLIDB typically require the database schema to be provided as input to the neural network. In other words, the neural network may not be able to learn the schema of the database from the training data. As a result, the neural network may not be able to generate accurate formal queries for queries that involve entities that are not explicitly mentioned in the training data.

The current approach to training neural networks for NLIDB typically involves training the neural network on a fixed set of training data. In other words, the neural network may not be updated to improve performance of the neural network as new data becomes available. As a result, the neural network may not be able to generate accurate formal queries for queries that involve entities or relationships that are not present in the training data. These problems may lead to a number of issues with the performance of neural networks for NLIDB. For example, neural networks trained on manually generated or weakly templated training data may not be able to generate accurate formal queries for queries that are not similar to the queries in the training data. Additionally, neural networks that are not able to learn the content of the database may not be able to generate accurate formal queries for queries that involve multiple entities.

Finally, neural networks that are not able to learn the schema of the database may not be able to generate accurate formal queries for queries that involve entities that are not explicitly mentioned in the training data. The disclosed techniques involve programmatically generating pairs of natural language questions and their corresponding formal queries.

In one implementation, machine learning system 204 may be configured to generate relevant training examples to translate natural language queries to executable database queries. The machine learning system may start with analyzing the data in the database to identify key concepts, relationships, and patterns. In an aspect, machine learning system 204 may generate, based on the data analysis, relevant questions in natural language. The machine learning system 204 may generate relevant questions by using a variety of techniques, such as, but not limited to, template-based generation, rule-based generation, and statistical generation.

Machine learning system 204 may select appropriate vocabulary to use based on the domain expertise of the user. In one non-limiting example, domain experts may be consulted with to identify the terms that are commonly used in the domain. The meaning of the vocabulary may be defined in terms of how it is used to process the data.

In an aspect, machine learning system 204 may define the meaning of vocabulary by creating a mapping between the natural language terms and the formal query language constructs. Formal query generation module 126 may generate formal queries based on the meaning definitions. Machine learning system 204 may generate the formal queries by using a grammar that understands the formal query language. Next, machine learning system 204 may generate natural language queries based on the formal queries. The natural language queries may be generated by using a general grammar that understands the formal query language. In an aspect, the natural language queries may be generated by using a contextual grammar provided by parameterized contextual grammar module 132.

The disclosed techniques allow users to query databases, such as database repository 134, using natural language without having to know the formal query language. Machine learning system 204 is able to generate formal queries because neural network 130 is trained using the data in database repository 134 and the general grammar, such that trained neural network 130 can understand the meaning of the vocabulary used by the user.

The creation of the general grammar of the formal language is important because the general grammar may allow machine learning system 204 to generate natural language queries that are equivalent to formal queries. The creation of the general grammar of the formal language is also important because the general grammar may allow users to interact with the database using natural language, which is more user-friendly than using a formal query language. In an aspect, the general grammar may be created by analyzing the structure of formal queries. In an aspect, creation of the general grammar may involve machine learning system 204 identifying the different types of clauses, phrases, and words that may be used in formal queries. The grammar may then specify the rules for how these elements may be combined to form valid formal queries. In an aspect, the machine learning system 204 may use a parameterized contextual grammar instead, as described below.

Once the grammar has been created, machine learning system 204 may use the grammar to generate training examples. Training examples include pairs of natural language queries and their corresponding formal queries. In an aspect, the machine learning system 204 may use these training examples to train neural network 130. Neural network 130 may in this way learn to generate formal queries that are equivalent to natural language queries.

The development of general grammars for formal query languages may make it possible to efficiently create natural language interfaces to different databases because the general grammar may be used to generate training examples for a natural language generation model. The natural language generation model may then be used to generate natural language queries that are equivalent to formal queries.

The disclosed techniques have a number of advantages over traditional approaches to creating natural language interfaces to databases. First, the disclosed techniques may be more efficient because these techniques do not require the creation of a separate natural language processing (NLP) model for each database. Second, the disclosed techniques may provide more accurate results because the natural language generation model may be trained on a large number of training examples that are generated from the general grammar. Third, the disclosed techniques may be more flexible because the general grammar may be used to generate natural language queries for any database that uses the same formal query language. As a result, the development of general grammars for formal query languages may be a significant step towards making it possible to efficiently create natural language interfaces to different databases.

In an aspect, the development of general grammars may make it easier for users to access and interact with data, regardless of their technical expertise. In addition to the benefits listed above, the use of general grammars may also help to improve the consistency of natural language interfaces because the natural language generation model may be trained on a consistent set of rules. As a result, the natural language queries that are generated may be more likely to be consistent in terms of their style and structure.

The above techniques are described with respect to a single machine learning system 204 implemented by computing system 200. However, aspects of machine learning system 204 may be distributed among multiple systems. For example, a first training data generation system may generate the training pairs as described herein. A second machine learning system 204 may process the training pairs to train neural network 130. Finally, a third system can apply the trained neural network 130 to process natural language queries receives from a user and translate the natural language queries to formal queries and, in this way, provide a natural language interface to a database.

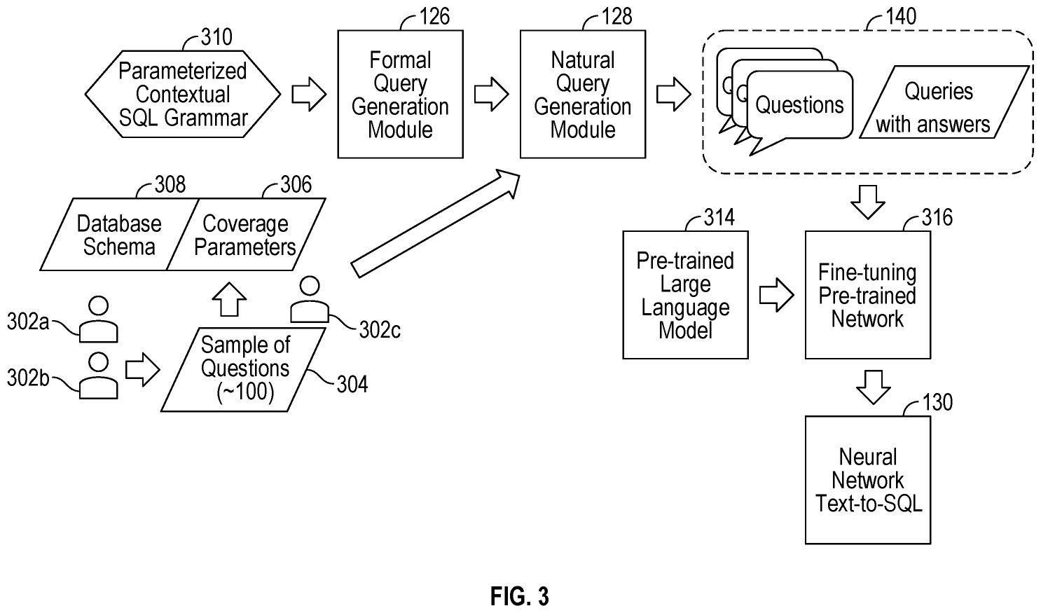

FIG. 3 is a conceptual diagram illustrating an example of a data augmentation framework according to techniques of this disclosure. In an aspect, such data augmentation may be implemented by using grammar-based techniques to generate natural language questions and rule-based techniques to generate formal queries. The grammar-based techniques may use a set of rules to generate natural language questions that are grammatically correct and semantically meaningful. The rule-based techniques may use a set of rules to generate formal queries that are syntactically correct and semantically equivalent to the natural language questions. This illustrated framework incorporates formal query generation module 126, natural query generation module 128, pre-trained LLM 314, fine-turning pre-trained network 316, and neural network 130 described above with respect to FIGS. 1-2.

The disclosed framework has a number of advantages over traditional approaches to generating training and testing data. First, the disclosed system is more cost-effective, as the disclosed system does not require the manual creation of training and testing data. Second, the disclosed system is more scalable, as the disclosed system may be used to generate large amounts of training and testing data. Third, the disclosed system is more diverse, as the disclosed system may be used to generate a wide range of natural language questions.

In an aspect, the disclosed system may also involve the generation of context for multi-turn queries. The generation of context for multi-turn queries may be implemented by using history-based techniques to generate context. The history-based techniques may use the information from previous turns in the dialogue to generate context for the current turn. The history-based techniques may help to ensure that the natural language questions are generated in a way that is consistent with the previous turns in the dialogue.

Advantageously, the disclosed system may also involve the use of database content and schema when generating training and testing data by using content-based techniques to generate natural language questions and schema-based techniques to generate formal queries. The formal query generation module 126 may implement schema-based techniques that use a schema of database repository 134 to generate formal queries. The disclosed system has a number of advantages over traditional approaches to generating training and testing data. First, the disclosed system may help to ensure that the natural language questions are relevant to the data in database repository 134. Second, the disclosed system may help to ensure that the formal queries are syntactically correct and semantically equivalent to the natural language questions. The disclosed system may also involve the use of domain adaptation to improve the performance of neural network 130.

Domain adaptation is a technique that may be used to improve the performance of a neural network on a new domain by using information from a related domain. In this case, the disclosed machine learning system 204 may use information from the database content and schema to improve the performance of the neural network on the task of generating natural language questions and formal queries.

The disclosed technique has a number of advantages over traditional approaches to improving the performance of neural networks. First, the disclosed technique may be more cost-effective, as the disclosed technique does not require the collection of additional training data. Second, the disclosed technique is more scalable, as the disclosed technique may be used to improve the performance of the neural network 130 on a wide range of domains. Third, the disclosed technique may be more effective, as the disclosed technique may help to improve the performance of the neural network 130 on questions that are not well-represented in the training data.

In an aspect, one or more domain experts 302 may be used to generate input into machine learning system 204. For example, domain expert 302a may include a chemist who may provide expertise on the chemical compounds and bioactivities stored in database repository 134. As another non-limiting example, domain expert 302b may include a biologist who may provide expertise on the relationships between the different entities in database repository 134. As yet another non-limiting example, technical domain expert 302c may include a computer scientist who may provide expertise on the database schema and the formal query language used to query database repository 134.

In an aspect, domain experts 302 may generate a plurality of sample questions 304 that may be used as input 210 into machine learning system 204.

The following are non-limiting examples of the questions that may be generated by the domain experts 302:
“What are the compounds that have a potency of at least 1000 and a weight smaller than 100 Da?”
“What are the bioactivities that are associated with the compound with the identifier CPD-0001?”
“What are the compounds that are similar to the compound with the identifier CPD-000?”

In addition to sample questions 304, input data 210 into machine learning system 204 may include one or more coverage parameters 306. The one or more coverage parameters 306 may include but are not limited to: the number of natural language questions that are generated, the diversity of the natural language questions that are generated, the relevance of the natural language questions to the data in database repository 134, and the like.

Furthermore, input data 210 into the machine learning system 204 may include database schema 308. Database schema 308 is a description of the structure of the data in database repository 134. Database schema 308 may include information about the tables in database repository 134, the columns in the tables, and the relationships among the tables.

As a non-limiting example, for a chemistry domain, database schema 308 may include: a first table named compound having the columns identifier, name, potency and weight; a second table named bioactivities having the columns identifier and name; and a third table named compound_bioactivities having the columns compound_identifier and bioactivity_identifier. The question generated by natural language query generation module 128 based on the aforementioned schema 308 may be: “What are the compounds that have a potency of at least 1000 and a weight smaller than 100 Da?” The formal query generated by the formal query generation module 126 based on the aforementioned generated question may be:
“SELECT *
FROM compounds
WHERE potency >=1000 AND weight <100”.

Parameterized contextual grammar module 132 may be configured to generate a parameterized contextualized grammar 310 that is able to generate formal language queries (e.g., SQL queries) based on a set of parameters. The parameters may include, but are not limited to database schema 308, the state of a multi-turn query, and the desired level of diversification. The contextual part of grammar 310 may represent the state of a multi-turn query. In other words, grammar 310 generated by parameterized contextual grammar module 132 may take into account the information that has been exchanged in previous turns of the dialogue. For example, if the user has asked for a list of compounds with a certain property, contextual grammar module 132 may use this information to generate SQL queries that are relevant to the user's request.

Formal query generation module 126 may be configured to generate queries that can be translated into questions that are similar to sample questions 304 from experts 302. In other words, formal query generation module 126 may take into account the vocabulary and style of the experts' sample questions 304. Formal query generation module 126 may also be configured to generate queries that are diversified. In other words, formal query generation module 126 may generate a variety of different queries that are relevant to the user's request.

In an aspect, for a visualization grammar language, such as Vega, the notion of database schema 304 may be replaced with the notion of a language schema. A language schema may be a description of the structure of a natural language. In other words, formal query generation module 126 may take into account the grammar and semantics of the natural language when generating formal language queries.

Natural language query generation module 128 may be configured to generate questions that are similar to sample questions 304. In other words, natural language query generation module 128 may take into account the way that users typically express their questions. Natural language query generation module 128 may also be configured to generate questions that are precise. In other words, natural language query generation module 128 may avoid generating questions that are ambiguous or misleading. The generated questions may use values from database repository 134. In other words, natural language query generation module 128 may use the data in database repository 134 to generate questions that are more informative and engaging. In an aspect, hundreds of thousands of training/testing pairs 140 of questions and queries may be used to train neural network 130. This training may help to ensure that neural network 130 is able to generate high-quality questions.

A pre-trained large language model (LLM) 314 may be a neural network that has been trained on a massive dataset of text and code. This training process may allow the LLM 314 to learn the statistical relationships between words and phrases in the natural language. As a result, the LLM 314 may be able to generate text, translate languages, write different kinds of creative content, and answer questions in an informative way. Fine-tuning 316 is a technique that may be used to improve the performance of the neural network 130 on a specific domain. The fine-tuning 316 may be implemented by training the neural network 130 on a dataset of training/testing pairs 140 that are specific to the domain. Directly improving fine-tuning 316 using the pre-trained LLM 314 may help to make the neural network 130 more efficient because such improvement may allow the neural network 130 to learn the specific task of generating natural language queries from SQL queries more quickly. For example, the neural network 130 that is fine-tuned on a large dataset of pairs 140 of formal queries and natural language queries may be able to generate accurate natural language queries even if the methodology used to extend the neural network 130 to a new domain is not as complex. Another way to find a good balance may be to use a technique called transfer learning.

Transfer learning is a technique that may allow the neural network 130 trained on one domain to be used as a starting point for training the neural network 130 on another domain. Transfer learning may be useful for making the neural network 130 more efficient because it may allow the neural network 130 to leverage the knowledge it has learned from training on other domains.

The main advantages of the techniques illustrated in FIG. 3 to data augmentation by automatic generation of training/testing pairs 140 may include, but are not limited to: efficient generation of training data at scale and automated generation of correct queries. Different modules illustrated in FIG. 3 may be used to generate large amounts of training data for the neural network 130. Such generation may be important because neural network 130 may require a lot of training data to be effective. Parameterized grammars 310 may be used to generate correct formal queries (e.g., SQL queries) from natural language queries. Parameterized grammars 310 may be important because neural network 130 may need to be able to generate correct SQL queries in order to interact with database repository 134. In addition to these advantages, the disclosed techniques for data augmentation may also have a number of other benefits, such as, but not limited to: scalability, flexibility, and accuracy. A neural network trained based on the disclosed techniques may be scaled to support a large number of users and databases. In addition, such neural network may be customized to support different domains and languages (both natural languages and database programming languages). As yet another advantage, sample questions 304 from domain experts 302 may provide a set of realistic natural language queries that neural network 130 is expected to be able to handle.

For example, if neural network 130 is being trained for the database repository 134 containing medical records, sample questions 304 from domain experts 302 may include, but are not limited to questions such as the following. What are the patient's vital signs? What are the patient's allergies? What medications is the patient taking? What is the patient's diagnosis? By training neural network 130 on sample questions 304 from domain experts 302, neural network 130 may be more likely to be able to generate accurate and informative responses to users' queries.

Parameterized contextual grammars 310 may be created once for all databases that use the same query language. Parameterized contextual grammars 310 are a type of grammar that may be used to generate SQL queries for different databases because parameterized contextual grammars 310 may use parameters to represent the different parts of a SQL query. The parameters may then be replaced with specific values to generate a SQL query for a specific database. For example, the following parameterized grammar could be used to generate the SQL query:
“SELECT *
FROM customers
WHERE name=?”
for any database that uses the SQL query language:
“SELECT *
FROM {table}
WHERE {column}=?”
The {table} and {column} parameters may be replaced with the specific table name and column name to generate a SQL query for a specific database. Creating parameterized contextual grammars 310 once for all databases that use the same query language may save time and effort.

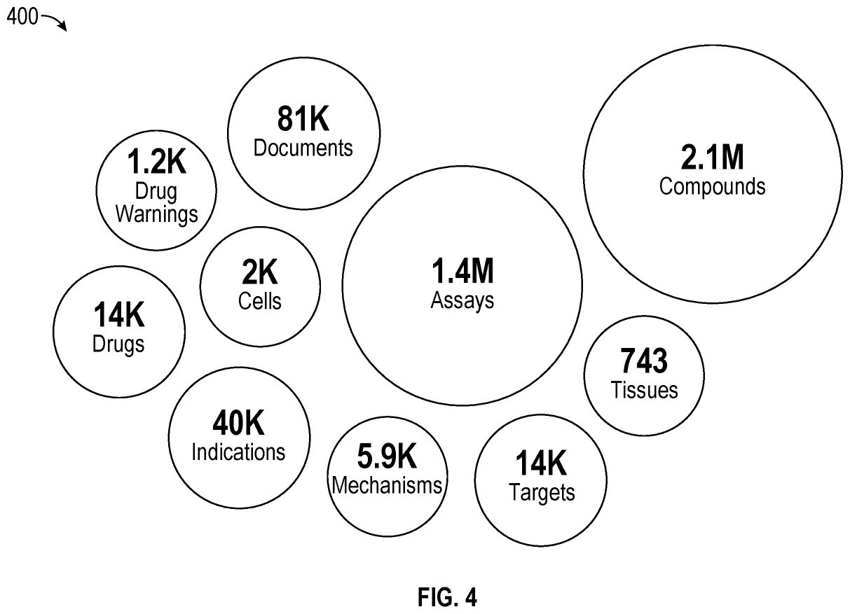

FIG. 4 is a conceptual diagram illustrating example scientific database according to techniques of this disclosure. ChEMBL (Chemical Biology Database) 400 shown in FIG. 4 is a manually curated database of bioactive molecules with drug-like properties. The ChEMBL 400 brings together chemical, bioactivity and genomic data to aid the translation of genomic information into effective new drugs. ChEMBL 400 contains data on over 2 million bioactive compounds, including their chemical structures, biological activities, and target proteins.

The ChEMBL database 400 may also include information on the relationships between the bioactive compounds, such as similarities in structure and activity. ChEMBL 400 is a valuable resource for drug discovery researchers, as this database may provide them with a comprehensive and well-curated database of information on potential drug candidates. The ChEMBL database 400 may be used to identify new drug targets, design new drug molecules, and predict the properties of new drugs. Following are some examples of how ChEMBL 400 may be used in drug discovery. A researcher may use the ChEMBL 400 to identify all of the compounds that have been shown to bind to a particular protein target. The identified information may be used to design new drugs that target the same protein. A researcher may use the ChEMBL 400 to identify compounds that are similar to a known drug but have different properties. The identified compound information may be used to design new drugs that are more effective or have fewer side effects. A researcher may use the ChEMBL 400 to predict the properties of a new drug, such as its toxicity and absorption. The predicted information may be used to decide whether or not to develop the drug further.

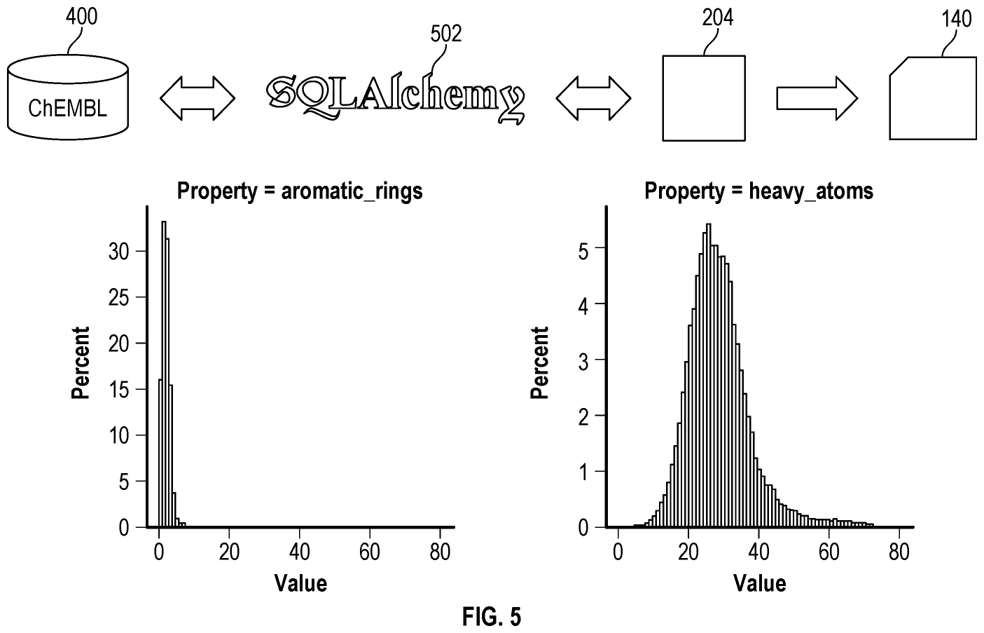

FIG. 5 is a conceptual diagram illustrating an example query generation method according to techniques of this disclosure. Sampling values from database repository 134 to drive the query generation process is a way to address the challenge of not knowing which values users will use when searching for molecules and assays, for example. By sampling values from database repository 134, machine learning system 204 may generate a variety of queries that are likely to be relevant to users, even if the users do not know the specific values that they are looking for. For example, if a user is interested in finding molecules with a certain potency, machine learning system 204 may sample values from the database for potency and may generate queries that search for molecules with a potency greater than, equal to, or less than the sampled value. Machine learning system 204 may also generate queries that search for molecules with a potency within a certain range. Similarly, if a user is interested in finding assays with a certain bioactivity, machine learning system 204 may sample values from the database for bioactivity and may generate queries that search for assays with a bioactivity greater than, equal to, or less than the sampled value. Machine learning system 204 may also generate queries that search for assays with a bioactivity within a certain range.

Sampling values from columns and combining clauses are techniques that may be used by the machine learning system 204 to narrow down formal queries and create a representative sample of data, especially when dealing with large datasets. Such techniques may be particularly useful when the actual queries are either not available or too complex to analyze directly. Sampling may involve selecting a subset of data from a larger dataset. Sampling may be implemented using various techniques, such as, but not limited to, random sampling, stratified sampling, or systematic sampling. The choice of sampling method may depend on the specific characteristics of the data and the desired representativeness of the sample. Combining clauses may involve using logical operators (AND, OR, NOT) to connect multiple conditions in a query. Such combinations may allow for more precise filtering of the data, ensuring that only the relevant subsets are included in the sample. By combining sampling techniques with appropriate clauses, it is possible to create a representative sample that accurately reflects the overall characteristics of the larger dataset. This sample may then be used to conduct preliminary analysis, identify trends, and develop hypotheses, which can guide further investigation using the complete dataset. Sampling may reduce the amount of data to be processed, making it computationally more efficient for analysis.

In one example of the disclosed system and methods, a general-purpose middleware component may be used to interface with a scientific database, such as, but not limited to ChEMBL 400. An example of such a middleware component 502 is SQLALCHEMY™. The middleware component 502 may enable a user to support a variety of SQL databases with the same code because it may compile to the user's dialects. The disclosed techniques contemplate a parameterized grammar of SQL because one or more tools may automatically generate this interface to the middleware component 502. A parameterized grammar of SQL is a way to express SQL queries in a way that is independent of the specific database dialect. The parameterized grammar of SQL may be implemented by using parameters in the query that may be replaced with specific values at runtime.

For example, the following parameterized SQL query could be used to select all molecules from a scientific database that have a particular molecular weight:
SELECT *
FROM molecules
WHERE molecular_weight=:molecular_weight;

To generate a specific SQL query for a particular database dialect, the disclosed system may simply replace the :molecular_weight parameter with the appropriate column name for that database. For example, to generate a SQL query for the MySQL dialect, the disclosed system may replace the :molecular_weight parameter with the molecule_weight column name:
SELECT *
FROM molecules
WHERE molecule_weight=:molecular_weight;

The middleware component 502 may provide a number of tools that may be used to automatically generate this interface to SQL. For example, an Object-Relational Mapper (ORM) may be used to generate a Python class for each table in the database. The Python class may then be used by the system to interact with the scientific database using Python objects. In the example of using middleware component 502 to interface with ChEMBL 400, the disclosed system may support 18 properties for molecules and 9 properties for assays. In other words, the disclosed system may generate SQL queries to select, insert, update, and delete molecules and assays from the ChEMBL database 400.

By sampling values from the ChEMBL database 400, machine learning system 204 may generate a variety of queries that are likely to be relevant to users, even if the users do not know the specific values that they are looking for. This is a valuable feature, as such feature may help users to find the information that they need more quickly and easily. In addition to the example 18 properties for molecules and 9 properties for assays, machine learning system 204 may also sample values from other properties in the database, such as the chemical structure of the molecule, the target protein of the assay, or the disease that the assay is used to study. The sampled values may allow machine learning system 204 to generate even more specific and relevant queries for users.

In an aspect, using middleware component 502 to interface with the ChEMBL 400 may be a good way to support a variety of SQL databases with the same code. The middleware component 502 may be a general-purpose ORM that may be used to interact with relational databases in Python. The middleware component 502 may provide a unified interface to different database dialects, which may make it possible to write code that may be used with different databases without having to make any changes.

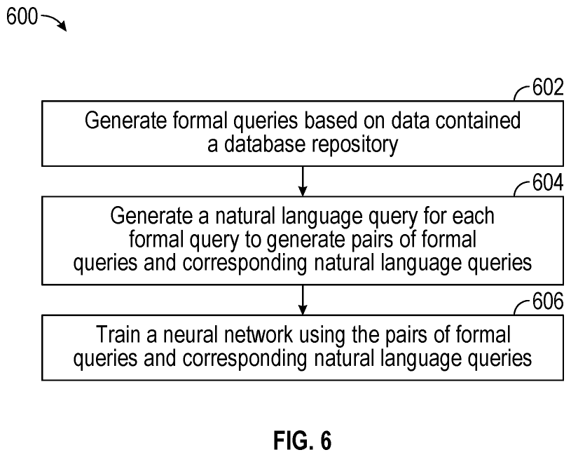

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computation system with respect to other examples of machine learning systems described herein.

In mode operation 600, processing circuitry 243 executes machine learning system 204. Machine learning system 204 may generate one or more formal queries based on data contained a database repository (602) using the formal query generation module 126. Machine learning system 204 may next generate a natural language query for each formal query of the one or more formal queries to generate pairs of formal queries and corresponding natural language queries (604). In an aspect, the natural language query generation module 128 component of the machine learning system 204 may take into account the way that users typically express their questions. Next, machine learning system 204 may train the neural network 130 configured to translate natural language queries into formal queries using pairs of the one or more formal queries and corresponding natural language queries (606). In an aspect, the neural network 130 may learn to generate formal queries that are equivalent to natural language queries.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for generating training examples, the method comprising:
generating, by a machine learning system, one or more formal queries based on data contained in a database repository;
generating, by the machine learning system, a natural language query for each formal query of the one or more formal queries to generate pairs of formal queries and corresponding natural language queries by applying a general grammar for a language of each formal query; and
training, by the machine learning system, a neural network configured to translate natural language queries into formal queries using the pairs of the formal queries and corresponding natural language queries generated by the machine learning system.

2. The method of claim 1, wherein generating the one or more formal queries further comprises selecting a subset of the data contained in the database repository by randomly sampling values contained in the database repository and filtering the selected subset to generate one or more representative formal queries.

3. The method of claim 1, further comprising receiving, prior to the generation of the one or more formal queries, a database schema describing structure of the data in the database repository.

4. The method of claim 1,
wherein the database repository comprises a scientific relational database, and
wherein the data contained in the database repository comprises scientific data.

5. The method of claim 1, wherein generating one or more formal queries based on data contained in the database repository comprises generating the one or more formal queries based on one or more sample questions provided by one or more domain experts.

6. The method of claim 1, wherein generating the one or more formal queries comprises generating one or more parameterized SQL queries using a parameterized grammar.

7. The method of claim 6, wherein generating the one or more formal queries comprises generating context for multi-turn SQL queries.

8. The method of claim 7,
wherein the multi-turn query comprises at least a first SQL query and a second SQL query, and
wherein the second SQL query is generated based on information returned by the first SQL query.

9. The method of claim 1, further comprising:
processing, by a trained neural network, an input natural language query to predict a formal query for the input natural language query.

10. A computing system comprising:
processing circuitry in communication with storage media, the processing circuitry configured to execute a machine learning system configured to:
generate one or more formal queries based on data contained in a database repository; generate a natural language query for each formal query of the one or more formal queries to generate pairs of formal queries and corresponding natural language queries by applying a general grammar for a language of each formal query; and
train a neural network configured to translate natural language queries into formal queries using the pairs of the formal queries and corresponding natural language queries.

11. The system of claim 10, wherein the machine learning system configured to generate the one or more formal queries is further configured to select a subset of the data contained in the database repository by randomly sampling values contained in the database repository and to filter the selected subset to generate one or more representative formal queries.

12. The system of claim 10, wherein the machine learning system is further configured to:
receive, prior to the generation of the one or more formal queries, a database schema describing structure of the data in the database repository.

13. The system of claim 10,
wherein the database repository comprises a scientific relational database, and
wherein the data contained in the database repository comprises scientific data.

14. The system of claim 10, wherein the machine learning system configured to generate one or more formal queries based on data contained in the database repository is further configured to generate the one or more formal queries based on one or more sample questions provided by one or more domain experts.

15. The system of claim 10, wherein the machine learning system configured to generate the one or more formal queries is further configured to generate one or more parameterized SQL queries using a parameterized grammar.

16. The system of claim 15, wherein the machine learning system configured to generate the one or more formal queries is further configured to generate context for multi-turn SQL queries.

17. The system of claim 16,
wherein the multi-turn query comprises at least a first SQL query and a second SQL query, and
wherein the second SQL query is generated based on information returned by the first SQL query.

18. Non-transitory computer-readable storage media having instructions encoded thereon, the instructions configured to cause processing circuitry to:
generate one or more formal queries based on data contained in a database repository;
generate a natural language query for each formal query of the one or more formal queries to generate pairs of formal queries and corresponding natural language queries by applying a general grammar for a language of each formal query; and
train a neural network configured to translate natural language queries into formal queries using the pairs of the formal queries and corresponding natural language queries.

19. The non-transitory computer-readable storage media of claim 18, wherein the instructions configured to cause the processing circuitry to generate the one or more formal queries are further configured to cause the processing circuit to select a subset of the data contained in the database repository by randomly sampling values contained in the database repository and to filter the selected subset to generate one or more representative formal queries.

20. The non-transitory computer-readable storage media of claim 18, wherein the instructions are further configured to cause the processing circuitry to:
receive, prior to the generation of the one or more formal queries, a database schema describing structure of the data in the database repository.

21. The non-transitory computer-readable storage media of claim 18,
wherein the database repository comprises a scientific relational database, and
wherein the data contained in the database repository comprises scientific data.

22. A method comprising:
processing, by a trained neural network, a natural language query to predict a formal query,
wherein the trained neural network is trained using pairs of formal queries and corresponding natural language queries generated by a machine learning system that generates the formal queries based on data contained in a database repository and generates the corresponding natural language queries for each of the formal queries.
